(19) United States
(12) Patent Application Publication
(10) Pub. No.: US 2011/0030641 A1
(43) Pub. Date: Feb. 10, 2011

(54) THROTTLE LOSS RECOVERY AND SUPERCHARGING SYSTEM FOR INTERNAL COMBUSTION ENGINES

(75) Inventors: Shouhao Wu, Roselle, IL (US); Robert L. Rowells, Elmwood Park, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/536,549

(22) Filed: Aug. 6, 2009

(51) Int. Cl. F02M 35/10; F16D 31/02

(52) U.S. Cl. 123/184.56; 60/413

(57) ABSTRACT

A system and method of creating sub-atmospheric and super-atmospheric pressure in an intake manifold (20) of an internal combustion engine (10) that has cylinders (14) within which fuel combusts with air that has entered the cylinders via the intake manifold. A positive displacement airflow control device (26) is disposed upstream of the intake manifold. Sub-atmospheric pressure in the intake manifold is created by applying negative external torque to a shaft (28) of the positive displacement airflow control device and super-atmospheric pressure is created by applying positive external torque to the shaft (28).

### FIELD OF THE DISCLOSURE

The technical field of this disclosure concerns internal combustion engines, including both compression ignition and spark ignition engines, that during some modes of operation throttle air flow to intake manifolds and during other modes of operation supercharge air flow to intake manifolds.

### BACKGROUND OF THE DISCLOSURE

Although some internal combustion engines operate without a throttle (sometimes referred to as unthrottled engines), typical internal combustion engines that propel motor vehicles like cars and trucks have intake air throttles to regulate the intake air flow rate. Stoichiometric combustion engines (such as gasoline engines or natural gas engines) that are naturally aspirated continuously control the throttle either directly by a linkage from an accelerator pedal or through a throttle-positioning mechanism that is operated by an electronic controller using data from various sources including an accelerator pedal position sensor. Such engines operate to significantly throttle intake air flow at light engine loads, with the amount of throttling generally increasing as engine load decreases.

A diesel engine may use throttling during some running conditions to control intake air flow rate. A purpose in doing so is to achieve compliance with applicable tail pipe emission requirements.

Any throttling of intake air causes pressure loss and hence reduction in engine fuel economy because of the restriction created by the throttle. Fuel economy of a gasoline engine especially suffers when significant restriction of the intake air flow by a throttle causes the engine to work harder to draw air past the throttle.

### SUMMARY OF THE DISCLOSURE

This disclosure contemplates placement of a positive displacement airflow control device in an engine air intake system for recovering energy that would otherwise be lost due to throttling. It thereby becomes possible to recover significant amounts of energy when the engine air intake is being throttled, and hence enable fuel economy of a throttled engine to be improved. The energy that would otherwise be lost can converted into mechanical energy and/or a form of energy other than mechanical energy, such as electrical, hydraulic, or pneumatic.

Recovered energy, or other energy for another source, can be applied to the positive displacement airflow control device for supercharging the engine to improve engine performance.

Several different embodiments are presented in this disclosure.

One general aspect of the disclosure relates to an internal combustion engine comprising cylinders within which fuel combusts with air that has entered the cylinders via an intake manifold in an engine air intake system, and a positive displacement airflow control device that is disposed in the engine air intake system upstream of the intake manifold and has a shaft coupled to a conversion device that selectively applies to the shaft of the positive displacement airflow control device negative external torque for throttling intake airflow that results in the engine creating sub-atmospheric pressure in the intake manifold and positive external torque for causing the positive displacement airflow control device to create super-atmospheric pressure in the intake manifold.

Another general aspect of the disclosure relates to a method of creating sub-atmospheric and super-atmospheric pressure in an intake manifold of an intake system of an internal combustion engine that has cylinders within which fuel combusts with air that has entered the cylinders via the intake manifold, the method comprising operating a positive displacement airflow control device that is disposed in the engine intake system upstream of the intake manifold to selectively apply negative external torque to a shaft of the positive displacement airflow control device to throttle intake airflow that results in the engine creating sub-atmospheric pressure in the intake manifold and positive external torque to the shaft of the positive displacement airflow control device to create super-atmospheric pressure in the intake manifold.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a schematic diagram of an internal combustion engine according to a first embodiment.

FIG. 2 is a schematic diagram of an internal combustion engine according to a second embodiment.

FIG. 3 is a schematic diagram of an internal combustion engine according to a third embodiment.

FIG. 4 is a schematic diagram of an internal combustion engine according to a fourth embodiment.

### DETAILED DESCRIPTION

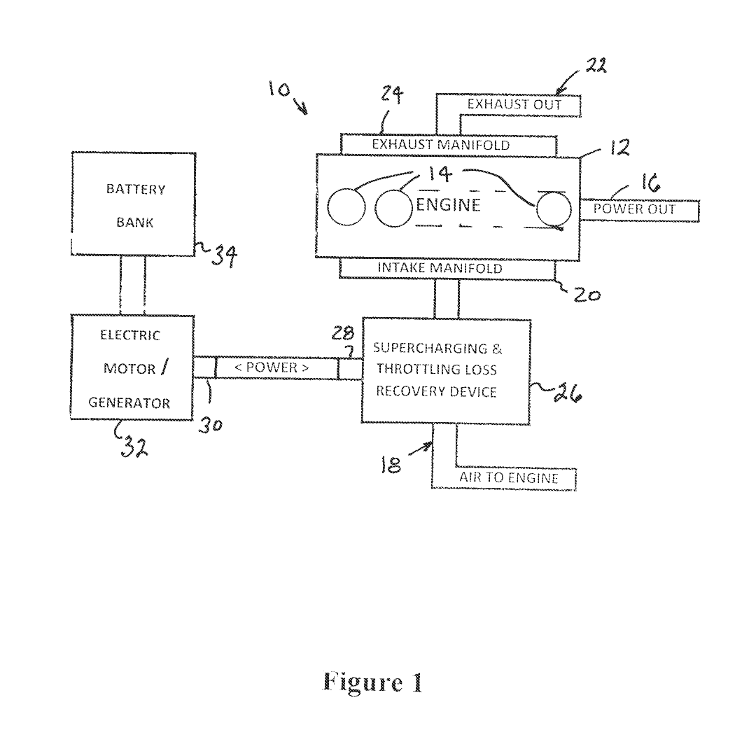

FIG. 1 shows an internal combustion engine 10 comprising structure 12 containing engine cylinders 14 within which fuel combusts with air to operate the engine by delivering torque to a power output shaft 16 that comprises a crankshaft journaled within structure 12 and operatively associated with cylinders 14 via connecting rods coupled to pistons that reciprocate within cylinders 14.

Engine 10 also comprises an air intake system 18, including an intake manifold 20 through which air enters cylinders 14 to support the combustion of fuel. Engine 10 further comprises an exhaust system 22, including an exhaust manifold 24 for conveying combustion-created exhaust gas from cylinders 14.

A supercharging and throttling loss recovery device 26 is disposed in air intake system 18 upstream of intake manifold 20. Device 26 comprises a shaft 28 coupled to a shaft 30 of a device 32.

Device 26 is a positive displacement airflow control device 26, one example of which is a Roots pump. Such a positive displacement device is one having a mechanism that when operating in a throttling mode to meter airflow through the device, develops torque in a shaft correlated with the pressure drop across the device, and that when operated in a charging mode (super-charging mode in the present disclosure) during which external torque is applied to the shaft, creates positive pressure, rather than a pressure drop, across the device.

Device 32 is a conversion device that is selectively operable to a first mode (throttling mode) for applying to shaft 28 via shaft 30 negative external torque to cause sub-atmospheric pressure to be created in intake manifold 20. Negative external torque means a torque load imposed by shaft 30 on shaft 28. Application of negative external torque to shaft 28 by shaft 30 occurs through speed/load control of shaft 30 that throttles the intake airflow. Because of this restriction, engine operation creates sub-atmospheric pressure (i.e., engine vacuum or suction) in intake manifold 20. The pressure difference that is thereby created across positive displacement airflow control device 26 provides the power by which shaft 28 drives shaft 30. In other words, the power loss due to throttling is recovered as the power that drives the torque load of shaft 30. The magnitude of the sub-atmospheric pressure is controlled by the magnitude of negative external torque imposed by shaft 30 on shaft 28.

Device 32 is also selectively operable to a second mode (supercharging mode) for applying to shaft 28 positive external torque to cause positive displacement airflow control device 26 to create super-atmospheric pressure in intake manifold 20. Positive external torque means the application of torque by shaft 30 tending to turn shaft 28.

FIG. 1 shows device 32 to be an electric motor/generator 32 for converting mechanical energy into electrical energy, and vice versa. A battery bank 34 comprising one or more D.C. storage batteries is associated with electric motor/generator 32.

When electric motor/generator 32 is operating as an electric generator, it applies negative external torque to shaft 28. This causes positive displacement airflow control device 26 to create sub-atmospheric pressure in intake manifold 20. Battery bank 34 stores electric charge being created by electric motor/generator 32 operating as an electric generator.

When operating as an electric motor, device 32 applies positive external torque to shaft 28. This causes positive displacement airflow control device 26 to create super-atmospheric pressure in intake manifold 20. Electric charge is drawn from battery bank 34 to operate electric motor/generator 32 as an electric motor.

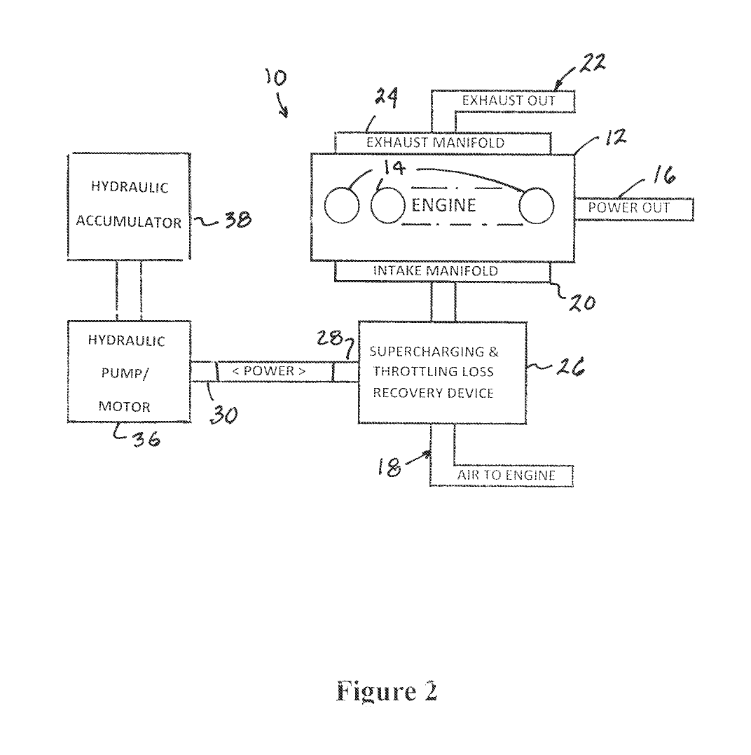

FIG. 2 shows an engine 10 that is similar to the one shown in FIG. 1 except for electric motor/generator 32 being replaced by a hydraulic pump/motor 36 for converting mechanical energy into hydraulic energy, and vice versa, and battery bank 34 being replaced by a hydraulic accumulator 38.

When hydraulic pump/motor 36 is operating as a hydraulic pump, it applies negative external torque to shaft 28, causing positive displacement airflow control device 26 to create sub-atmospheric pressure in intake manifold 20. Hydraulic fluid being pumped by hydraulic pump/motor 36 is forced into hydraulic accumulator 38 where it is stored under pressure.

When hydraulic pump/motor 36 is operating as a hydraulic motor, it applies positive external torque to shaft 28, causing positive displacement airflow control device 26 to create sub-atmospheric pressure in intake manifold 20. Hydraulic fluid for operating hydraulic pump/motor 36 as a hydraulic motor is being supplied by hydraulic accumulator 38.

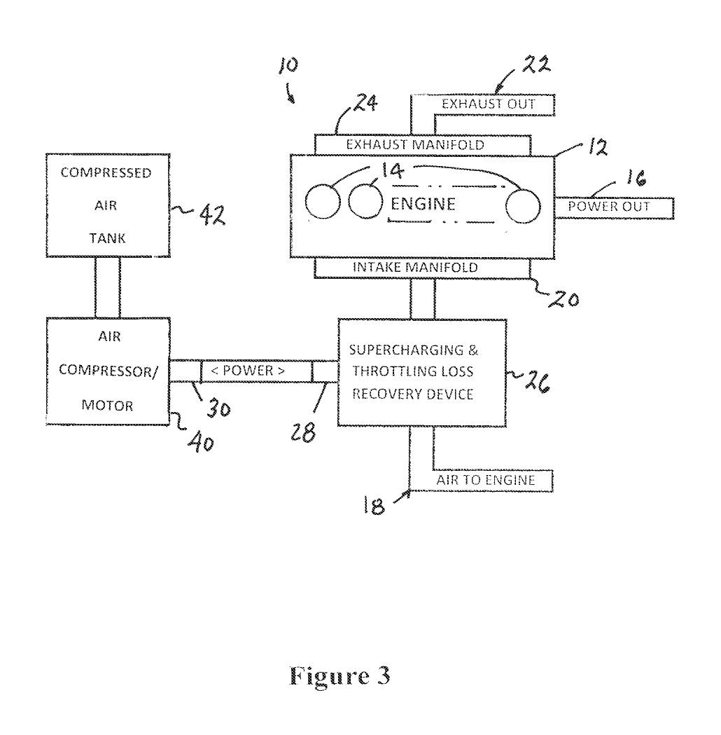

FIG. 3 shows an engine 10 that is similar to the one shown in FIG. 1 except for electric motor/generator 32 being replaced by an air compressor/motor 40 for converting mechanical energy into pneumatic energy, and vice versa, and battery bank 34 being replaced by a compressed air tank 42.

When air compressor/motor 40 is operating as an air compressor, it applies negative external torque to shaft 28, causing positive displacement airflow control device 26 to create sub-atmospheric pressure in intake manifold 20. Air being compressed is forced into tank 42 where it is stored under pressure.

When air compressor/motor 40 is operating as an air motor, it applies positive external torque to shaft 28, causing positive displacement airflow control device 26 to create sub-atmospheric pressure in intake manifold 20. Air for operating air compressor/motor 40 as an air motor is supplied by tank 42.

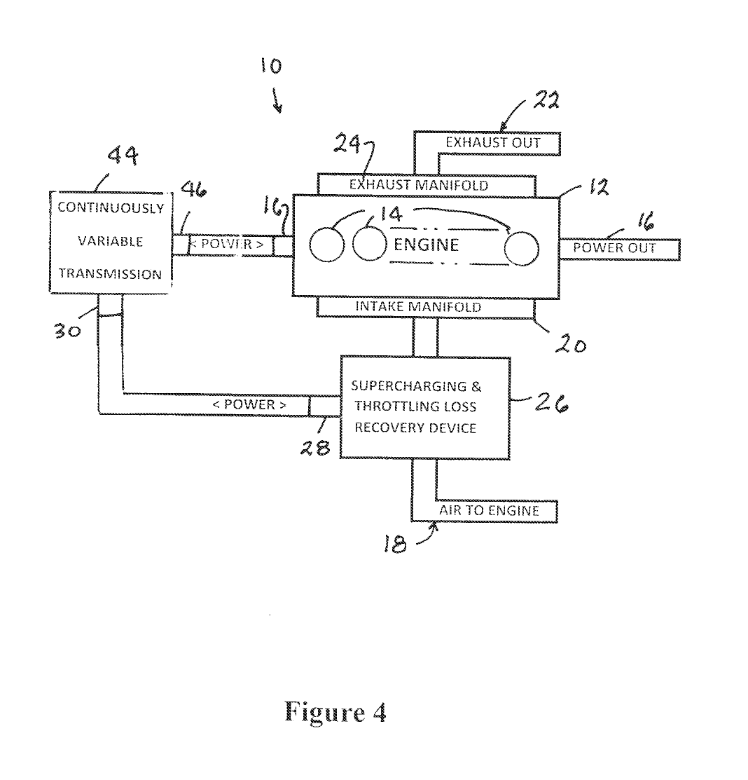

FIG. 4 shows an engine 10 that is similar to the one shown in FIG. 1 except for electric motor/generator 32 and battery bank 34 being replaced by a continuously variable transmission 44 having shaft 30 as a first shaft and a second shaft 46 that is coupled to power output shaft 16. Continuously variable transmission 44 can be operated to change the ratio of rotational speed of one of the shafts 44, 46 to rotational speed of the other, and is capable of bi-directional transmission of energy between the two shafts. In other words, torque can be transmitted from shaft 44 to shaft 46 when shaft 44 is producing greater torque, and from shaft 46 to shaft 44 when the former is producing greater torque, and by varying the speed ratio, the torque at the driven one of the two shafts can be varied. Hence, continuously variable transmission 44 can be considered a torque conversion device.

When torque is available at shaft 28 of positive displacement airflow control device 26, such as when engine 10 is running a light- or part-load condition (throttled mode), continuously variable transmission 44 operates to deliver that torque to power output shaft 16 while setting the speed of shaft 46 for correspondence with the speed of shaft 16.

When engine 10 operates in super-charged mode, torque is transmitted from power output shaft 16 through continuously variable transmission 44 to shaft 28 of positive displacement airflow control device 26 to create super-atmospheric pressure in intake manifold 20. The airflow rate can be regulated by controlling the speed of positive displacement airflow control device 26 through control of the speed ratio of continuously variable transmission 44.

It is possible to obtain significant improvements in fuel economy and performance of stoichiometric combustion engines. Improvement of fuel economy in diesel engines is also possible, depending on how often such engine use intake throttling.

What is claimed is:

1. An internal combustion engine comprising cylinders within which fuel combusts with air that has entered the cylinders via an intake manifold in an engine air intake system, and a positive displacement airflow control device that is disposed in the engine air intake system upstream of the intake manifold and has a shaft coupled to a conversion device that selectively applies to the shaft of the positive displacement airflow control device negative external torque for throttling intake airflow that results in the engine creating sub-atmospheric pressure in the intake manifold and positive external torque for causing the positive displacement airflow control device to create super-atmospheric pressure in the intake manifold.

2. An internal combustion engine as set forth in claim 1 in which the conversion device comprises an energy conversion device for converting mechanical energy of the shaft of the positive displacement airflow control device into a different form of energy.

3. An internal combustion engine as set forth in claim 2 in which the energy conversion device comprises an electric motor/generator that when operating as an electric generator applies negative external torque to the shaft of the positive displacement airflow control device for throttling intake airflow that results in the engine creating sub-atmospheric pressure in the intake manifold and when operating as an electric motor applies positive external torque to the shaft of the positive displacement airflow control device for causing the positive displacement airflow control device to create super-atmospheric pressure in the intake manifold.

4. An internal combustion engine as set forth in claim 3 including a battery bank for storing electric charge created by the electric motor/generator when the electric motor/generator is operating as an electric generator.

5. An internal combustion engine as set forth in claim 3 in which electric charge is drawn by the electric motor/generator from a battery bank when the electric motor/generator is operating as an electric motor to operate the positive displacement airflow control device.

6. An internal combustion engine as set forth in claim 2 in which the energy conversion device comprises a hydraulic pump/motor that when operating as a hydraulic pump pumping hydraulic fluid into a hydraulic accumulator applies negative external torque to the shaft of the positive displacement airflow control device for throttling intake airflow that results in the engine creating sub-atmospheric pressure in the intake manifold and when operating as a hydraulic motor drawing hydraulic fluid from the hydraulic accumulator applies positive external torque to the shaft of the positive displacement airflow control device for causing the positive displacement airflow control device to create super-atmospheric pressure in the intake manifold.

7. An internal combustion engine as set forth in claim 2 in which the energy conversion device comprises an air compressor/motor that when operating as an air compressor compressing air into an air tank applies negative external torque to the shaft of the positive displacement airflow control device for throttling intake airflow that results in the engine creating sub-atmospheric pressure in the intake manifold and when operating as an air motor by air from the air tank applies positive external torque to the shaft of the positive displacement airflow control device for causing the positive displacement airflow control device to create super-atmospheric pressure in the intake manifold.

8. An internal combustion engine as set forth in claim 1 in which the conversion device comprises a mechanical energy-to-mechanical energy conversion device for converting mechanical energy of the shaft of the positive displacement airflow control device into mechanical energy that has different physical characteristics from those of the mechanical energy of the shaft.

9. An internal combustion engine as set forth in claim 8 in which the mechanical energy-to-mechanical energy conversion device comprises a torque conversion device.

10. An internal combustion engine as set forth in claim 8 in which the mechanical energy-to-mechanical energy conversion device comprises a continuously variable transmission through which torque can be transmitted from a first member of the transmission to a second member of the transmission and vice versa, the first member is coupled to the shaft of the positive displacement airflow control device and the second member is coupled to a crankshaft of the engine that is operated by combustion within the engine cylinders, and the continuously variable transmission is operable to cause the crankshaft to selectively apply to the shaft of the positive displacement airflow control device negative external torque for throttling intake airflow that results in the engine creating sub-atmospheric pressure in the intake manifold and positive external torque for causing the positive displacement airflow control device to create super-atmospheric pressure in the intake manifold.

11. A method of creating sub-atmospheric and super-atmospheric pressure in an intake manifold of an intake system of an internal combustion engine that has cylinders within which fuel combusts with air that has entered the cylinders via the intake manifold, the method comprising operating a positive displacement airflow control device that is disposed in the engine intake system upstream of the intake manifold to selectively apply negative external torque to a shaft of the positive displacement airflow control device to throttle intake airflow that results in the engine creating sub-atmospheric pressure in the intake manifold and positive external torque to the shaft of the positive displacement airflow control device to cause the positive displacement airflow control device to create super-atmospheric pressure in the intake manifold.

12. A method as set forth in claim 11 in which the step of applying negative external torque to the shaft of the positive displacement airflow control device comprises operating an energy conversion device that is coupled to the shaft of the positive displacement airflow control device to convert mechanical energy of the shaft into a different form of energy and the step of applying positive external torque to the shaft of the positive displacement airflow control device comprises operating the energy conversion device by energy other than mechanical energy to apply positive external torque to the shaft of the positive displacement airflow control device.

13. A method as set forth in claim 11 in which the step of applying negative external torque to the shaft of the positive displacement airflow control device comprises operating an electric motor/generator that is coupled to the shaft of the positive displacement airflow control device as an electric generator and the step of applying positive external torque to the shaft of the positive displacement airflow control device comprises operating the electric motor/generator as an electric motor.

14. A method as set forth in claim 13 further comprising storing electric charge created by operation of the electric motor/generator as an electric generator in a battery bank.

15. A method as set forth in claim 13 further comprising drawing electric charge from a battery bank to operate the electric motor/generator as an electric motor for operating the positive displacement airflow control device.

16. A method as set forth in claim 11 in which the step of applying negative external torque to the shaft of the positive displacement airflow control device comprises operating a hydraulic pump/motor as a hydraulic pump to pump hydraulic fluid into a hydraulic accumulator, and the step of applying positive external torque to the shaft of the positive displacement airflow control device comprises operating the hydraulic pump/motor as a hydraulic motor operated by hydraulic fluid from the hydraulic accumulator.

17. A method as set forth in claim 11 in which the step of applying negative external torque to the shaft of the positive displacement airflow control device comprises operating an air compressor/motor as an air compressor to compress air into an air tank, and the step of applying positive external torque to the shaft of the positive displacement airflow control device comprises operating the air compressor/motor as an air motor operated by compressed air from the air tank.

18. A method as set forth in claim 11 in which the step of applying negative external torque to the shaft of the positive displacement airflow control device comprises operating a mechanical energy-to-mechanical energy conversion device that is coupled to the shaft of the positive displacement airflow control device to convert mechanical energy of the shaft of the positive displacement airflow control device into mechanical energy that has different physical characteristics from those of the mechanical energy of the shaft, and the step of applying positive external torque to the shaft of the positive displacement airflow control device comprises operating the mechanical energy-to-mechanical energy conversion device to convert mechanical energy from a source into mechanical energy applied to the shaft of the positive displacement airflow control device.

19. A method as set forth in claim 11 in which the step of applying negative external torque to the shaft of the positive displacement airflow control device comprises operating a torque converter to convert torque being applied to a first shaft of the torque converter by the shaft of the positive displacement airflow control device into torque at a second shaft of the torque converter, and the step of applying positive external torque to the shaft of the positive displacement airflow control device comprises converting torque being applied to the second shaft of the torque converter into torque that the first shaft of the torque converter is applying to the shaft of the positive displacement airflow control device.

20. A method as set forth in claim 11 comprising operating a continuously variable transmission through which torque can be transmitted from a first member of the transmission that is coupled to the shaft of the positive displacement airflow control device to a second member of the transmission that is coupled to a crankshaft of the engine that is operated by combustion within the engine cylinders and vice versa, for causing the crankshaft to selectively apply negative external torque and positive external torque to the shaft of the positive displacement airflow control device.
